(19) United States
(12) Patent Application Publication
(10) Pub. No.: US 2009/0037826 A1
(43) Pub. Date: Feb. 5, 2009

(54) Video conferencing system

(76) Inventor: Christopher Lee Bennetts, Hsin Tien City (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,359

(22) Filed: Jul. 31, 2007

(51) Int. Cl. G06F 3/00

(52) U.S. Cl. 715/753

(57) ABSTRACT

A video conferencing system, comprising a graphical user interface executable to cause a display of a source pane and a display pane, the source pane providing a listing of selectable interface modes, the display pane configured to display video content based on a selected video conference mode from the source pane.

### BACKGROUND

Video conferencing systems are used to provide multiple participants located at different locations the ability to communicate with each other. Such video conferencing systems utilize personal computers having web cameras and microphones to capture and transmit audio/video content to other users. However, in operation, such video conferencing systems are difficult to navigate and/or use (e.g., difficult to view participants and/or other media content), thereby increasing the complexity of the video communications.

### BRIEF DESCRIPTION OF THE DRAWINGS

FIG. 1 is a diagram illustrating an embodiment of a video conference system;

FIG. 2 is a block diagram illustrating an embodiment of an electronic device of the video conference system of FIG. 1;

FIG. 3 is a diagram illustrating an embodiment of a graphical user-interface of the video conference system of FIG. 1;

FIGS. 4A and 4B are diagrams illustrating the graphical user interface of FIG. 3 configured for use in a live video chat mode;

FIG. 5 is a diagram illustrating an embodiment of the graphical user interface of FIG. 3 configured for use in a video mailbox mode; and

FIGS. 6A-6D are diagrams illustrating an embodiment of the graphical user interface of FIG. 3 configured for use in a recorded video message mode.

### DETAILED DESCRIPTION OF THE DRAWINGS

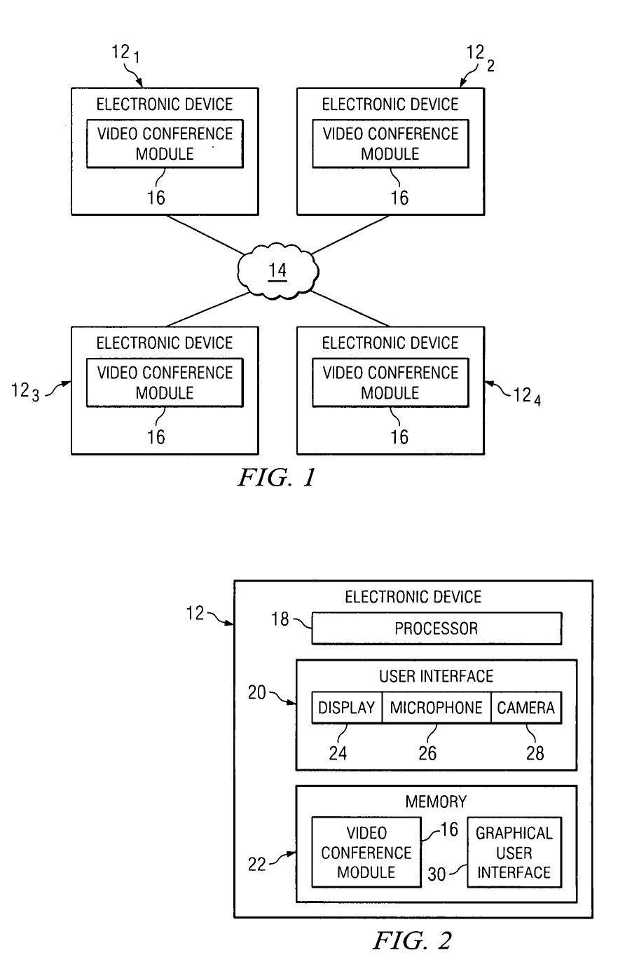

Various embodiments and the advantages thereof are best understood by referring to FIGS. 1-6D, like numerals being used for like and corresponding parts of the various drawings.

FIG. 1 is a diagram illustrating an embodiment of a video conferencing system 10. In the embodiment illustrated in FIG. 1, system 10 comprises a plurality of electronic devices 12₁, 12₂, 12₃ and 12₄ communicatively coupled via a communications network 14 to facilitate video communications between users of electronic devices 12₁, 12₂, 12₃ and 12₄. Electronic devices 12₁, 12₂, 12₃ and/or 12₄ may comprise any type of electronic device such as, but not limited to, a notebook or laptop computer, a desktop computer, a karaoke device, or any other type of portable or non-portable electronic device. In the embodiment illustrated in FIG. 1, four electronic devices 12₁, 12₂, 12₃ and 12₄ are illustrated; however, it should be understood that a greater or fewer number of electronic devices 12₁, 12₂, 12₃ and/or 12₄ may be used in connection with system 10. According to some embodiments, communications network 14 comprises a local area network; however, it should be understood that communications network 14 may be any type of wired and/or wireless communications network (e.g., the Internet, a cellular network, etc.) that enables video communications between electronic devices 12₁, 12₂, 12₃ and 12₄.

In the embodiment illustrated in FIG. 1, each electronic device 12₁, 12₂, 12₃ and 12₄ comprises a video conference module 16 to facilitate video communications among electronic devices 12₁, 12₂, 12₃ and 12₄. For example, according to some embodiments, electronic devices 12₁, 12₂, 12₃ and 12₄ are configured to transmit video content (e.g., a live video feed and/or a video message) via communications network 14 to other electronic devices 12₁, 12₂, 12₃ and/or 12₄. According to some embodiments, each electronic device 12₁, 12₂, 12₃ and/or 12₄ is configured to receive video content from other electronic devices 12₁, 12₂, 12₃ and/or 12₄ to enable each user to communicate with other users at their respective electronic devices 12₁, 12₂, 12₃ and 12₄. Accordingly, users of system 10 can participate in video communications at separate terminals (e.g., a separate electronic device 12₁, 12₂, 12₃ and/or 12₄).

FIG. 2 is a block diagram illustrating an embodiment of an electronic device 12 of video conference system 10 of FIG. 1 (e.g., representative of all or some of devices 12₁, 12₂, 12₃ and/or 12₄). In the embodiment illustrated in FIG. 2, electronic device 12 comprises a processor 18, a user interface 20 and a memory 22. In FIG. 2, user interface 20 comprises a display screen 24 for displaying information such as, but not limited to, video images of participants in a video conference, video messages and/or any other type of file. User interface 20 also comprises a microphone 26 to record a video participant's voice and a camera 28 to capture video images of the video participants. It should be understood that other types of interface and/or input/output devices may be used for inputting/outputting information relative to device 12. In FIG. 2, memory 22 comprises video conference module 16 and a graphical user interface 30. Video conference module 16 and graphical user interface 30 may comprise hardware, software, firmware, or a combination thereof. In FIG. 2, video conference module 16 and graphical user interface 30 are illustrated as being stored in memory 22 so as to be accessible and/or executable by processor 18. However, it should be understood that video conference module 16 and graphical user interface 30 may be otherwise stored, even remotely. In operation, video conference module 16 and graphical user interface 30 are configured to enable video conversations and/or video messaging between users of electronic devices 12₁, 12₂, 12₃ and/or 12₄.

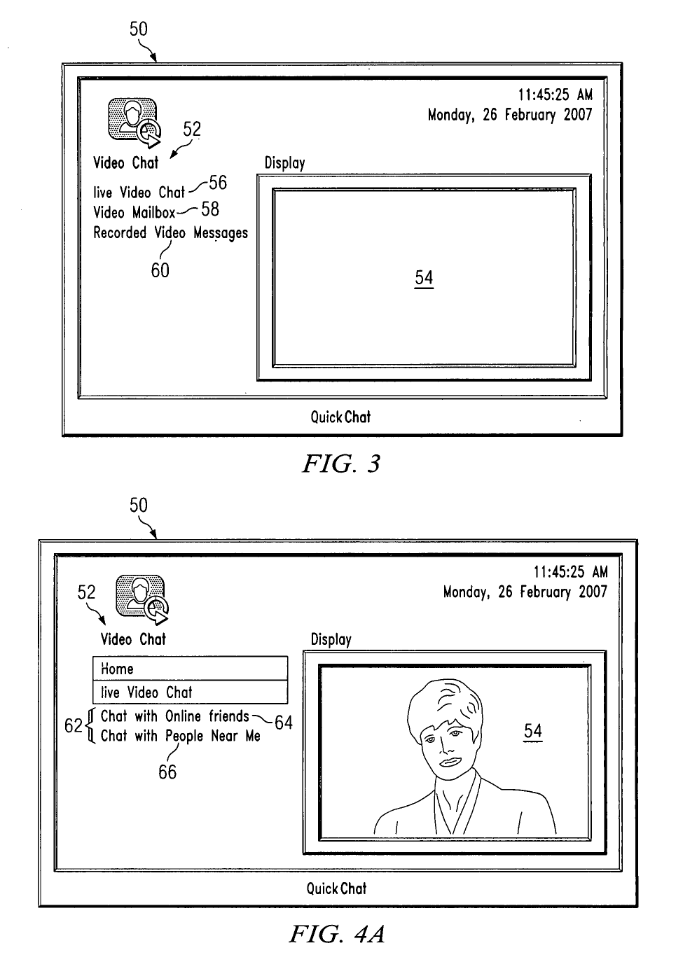

FIG. 3 is a diagram illustrating an embodiment of graphical user-interface 30 executable to display a source pane 52 and a display pane 54. In FIG. 3, source pane 52 enables a user to select a live video chat mode 56, a video mailbox mode 58, and a recorded video messages mode 60. For example, in FIG. 3, video chat mode 56 enables video conferencing between users one or more electronic devices 12₁, 12₂, 12₃ and/or 12₄, video mailbox mode 58 enables a user to receive, view and/or sort video emails, and recorded message mode 60 enables a user to record new video messages and review and respond to received video messages. In the embodiment illustrated in FIG. 3, display pane 54 enables a user to view video content therein while in any mode 56, 58 and/or 60. While three modes 56, 58 and/or 60 are illustrated in FIG. 3, it should be understood that a greater or fewer number of different communications modes 56, 58 and/or 60 may be displayed within source pane 52.

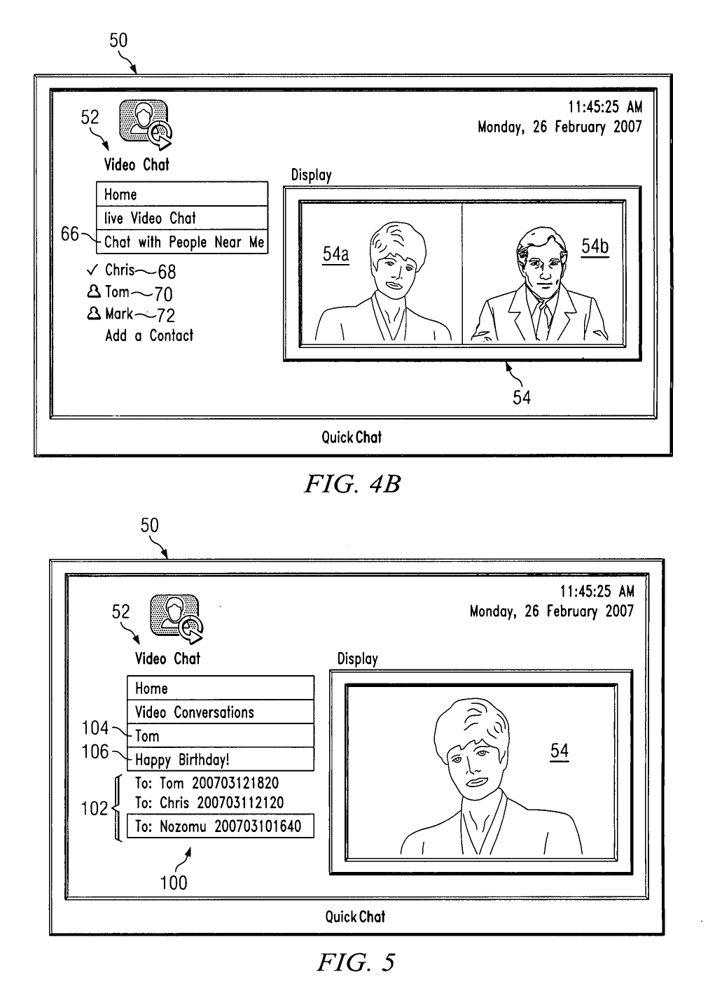

FIGS. 4A and 4B are diagrams illustrating graphical user interface 30 displaying input source pane 52 and display pane 54 in live video chat mode 56. Referring to FIG. 4A, source pane 52 comprises a menu 62 to enable a user to select the source and/or group of participants for a video chat. For example, in FIG. 4A, menu 62 comprises a “Chat with Online Friends” option 64 to enable a user to select video participants from selected online accounts via the Internet, and a “Chat with People Near Me” option 66 to enable a user to select video participants from a local subnet (e.g., participants currently logged on a local area network). In the embodiment illustrated in FIG. 4A, display pane 54 is configured to display the video feed associated with each selected video participant and/or source group.

Referring to FIG. 4B “Chat with People Near Me” option 66 is selected such that source pane 52 is populated with participants 68, 70 and/or 72 that are communicatively coupled via communications network 14 (FIG. 1). In the embodiment illustrated in FIG. 4B, three participants 68, 70 and/or 72 are illustrated; however, it should be understood that a greater or fewer number of participants 68, 70 and/or 72 may be listed within source pane 52.

In operation, a user of electronic device 12 (FIG. 1) selects one or more participants 68, 70 and/or 72 from source pane 52 to participate in a video conference using a mouse or other input device. For example, in FIG. 4B, participant 68 has been selected by the user of electronic device 12 to participate in the video conference. Once selected, interface 30 causes display pane 54 to automatically subdivide into sub-panes 54a and 54b to enable the display a video feed of each video conference participant. For example, in FIG. 4B, sub-pane 54a comprises video content of the user of electronic device 12₁ and sub-pane 54b comprises video content received from electronic device 12₂ of participant 68. It should be understood that display pane 54 may be further subdivided depending on the number of participants 68, 70 and/or 72 participating in the video chat.

According to some embodiments, interface 30 causes display pane 54 to dynamically subdivide into sub-panes 54a and 54b in response to selecting participants 68, 70 and/or 72. For example, in the embodiment illustrated in FIGS. 4A and 4B, as participant 68 is selected, display pane 54 dynamically adjusts from a single display pane 54 (FIG. 4A) so as to split into multiple sub-panes 54a and 54b (FIG. 4B) to display video content for each participant (e.g., video content of the users of electronic devices 12₁ and 12₂). The sizes, shapes, and/or locations of sub-panes may be user-controlled/varied and or automatically controlled/varied.

In operation, when it is desired to remove participant 68 from the video conference, participant 68 is de-selected in source pane 52, thereby causing sub-pane 54b to be automatically removed from source pane 52. For example, in FIG. 4B, when it is desired to remove participant 68 from the video conversation and thus display pane 52, the user of electronic device 12₁ using a mouse or other input device, deselects participant 68 from source pane 52. Once deselected, interface 30 automatically removed sub-pane 54b from display pane 54.

FIG. 5 is a diagram illustrating graphical user interface 30 of FIG. 3 in the video mailbox mode 58. In the embodiment illustrated in FIG. 5, source pane 52 comprises a video mailbox 100 and is configured to enable a user to categorize and/or otherwise organize video mail messages 102. For example, in FIG. 5 video mailbox 100 enables a user to categorize and/or otherwise organize video messages 102 corresponding to a particular person (e.g., sent to and/or received from) and further subdivided/sorted corresponding to a particular subject. For example, in the embodiment illustrated in FIG. 5, video messages 76 are organized/sorted by person 104 and by subject 106 (e.g., “Happy Birthday!”). In the embodiment illustrated in FIG. 5, video messages 102 for each particular subject 106 are further sorted in a predetermined order such as, for example, in a chronological or reverse chronological order. Thus, for example, messages 102 are ordered in a conversational order to enable a user to select each message to review the entire conversation of video messages 102 in a chronological order. According to some embodiments, messages 102 are chronologically ordered automatically upon receipt of each message 102.

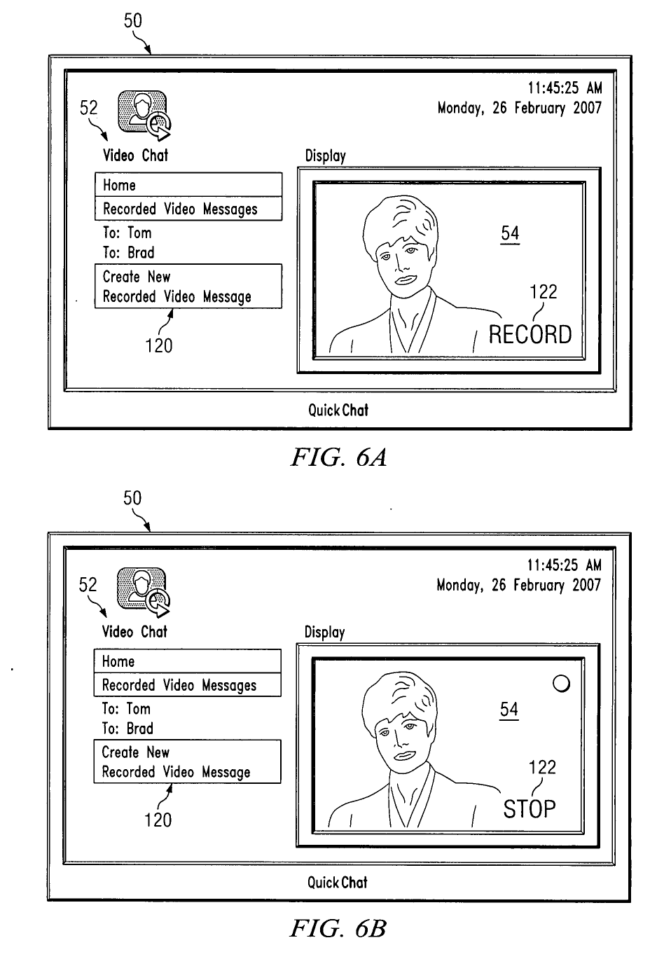

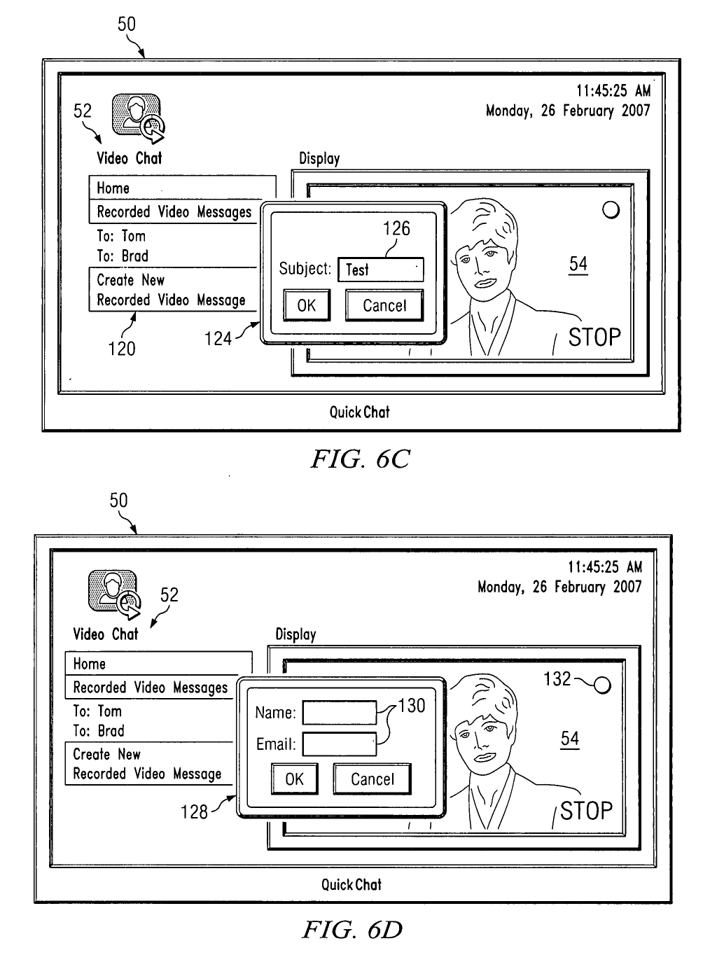

FIGS. 6A-6D are diagrams illustrating graphical user interface 30 of FIG. 3 in the recorded video message mode 60. In operation, when a user desires to record a new video message, the user selects “Create New Recorded Video Message” option 120. In response to selecting option 120, interface 30 causes display pane 54 to display a live webcam feed of the user of the particular electronic device 12. In the embodiment illustrated in FIG. 6A, display pane 54 comprises a command button 122 to facilitate recording a video message. For example, in FIG. 6A, to create and record a video message (e.g., a new video message or a reply video message to any of the video messages 102), command button 122 is pressed (using a mouse or other input device) to record the live webcam feed. In the embodiment illustrated in FIG. 6A, command button 122 comprises the word “Record” and is disposed within display pane 54; however, it should be understood that command button 122 may be otherwise configured (e.g., any type of symbol or word) to indicate to a user of electronic device 12 of the record function. In the embodiment illustrated in FIG. 6B, when command button 122 is selected to record the live video feed, interface 30 causes command button 122 to be reconfigured to display the word “Stop”. In operation, the user selects the stop command button 122 to stop recording the video message. In the embodiment illustrated in FIG. 6C, once the video messages is recorded, interface 30 causes a subject prompt 124 to be displayed to prompt the user to provide a video message subject 126. In the embodiment illustrated in FIG. 6D, interface 30 causes a prompt 128 to be displayed on user interface 30 to prompt the user to provide the video message recipient identification information 130 (e.g., the recipient's name and email address). According to some embodiments, when recording a video message, interface 30 causes a recording indicator 132 to be disposed within display pane 54 to alert and/or otherwise notify the user that a video message is being recorded.

Thus, embodiments of video conferencing system 10 comprise a video conference module 16 to enable user interface 30 to be configurable in a video conference mode to enable video participants to be added and removed to a display pane 54 during a video conference. Furthermore, embodiments of video conferencing system 10 comprise a user interface 30 configurable in a video mailbox mode to sort and enable a user to view video messages in a conversational order. Embodiments of video conferencing system 10 also comprise a user interface 30 configurable in a recorded video message mode to enable a user to record and send video messages. Furthermore, embodiments may be implemented in software and can be adapted to run on different platforms and operating systems. In particular, functions implemented by video conference module 16 and interface 30, for example, may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a computer-readable medium can be any means that can contain, store, communicate, propagate or transport the program for use by or in connection with the instruction execution system, apparatus or device. The computer-readable medium can be, for example but is not limited to, an electronic, magnetic, optical, electromagnetic, infrared, or semiconductor system, apparatus, device or propagation medium.

What is claimed is:

1. A video conferencing system, comprising:
a graphical user interface executable to cause a display of a source pane and a display pane, the source pane providing a listing of selectable interface modes, the display pane configured to display video content based on a selected video conference mode from the source pane.

2. The video conferencing system of claim 1, wherein the display pane is configured to automatically display a plurality of sub-panes.

3. The video conferencing system of claim 1, wherein the display pane is configured to automatically subdivide to display a plurality of sub-panes, each sub-pane corresponding to an added video conference participant.

4. The video conferencing system of claim 1, wherein the video conferencing modes comprise at least two of a live video chat mode, a video mailbox mode and a recorded video message mode.

5. A video conferencing system, comprising:
a graphical user interface executable to cause a display of a source pane and a display pane, the display pane configured to display video message content, the display pane comprising a command button disposed over the video message content to initiate a video command.

6. The video conferencing system of claim 5, wherein the command button comprises a reply button.

7. The video conferencing system of claim 5, wherein the command button comprises a record button.

8. The video conferencing system of claim 5, wherein the command button comprises a stop button.

9. A video conferencing system, comprising:
a graphical user interface executable to cause a display of a source pane and a display pane, the source pane configured to automatically list video files in an order corresponding to a video conversation for display within the display pane.

10. The video conferencing system of claim 9, wherein the predetermined order is associated with a predetermined person.

11. The video conferencing system of claim 9, wherein the predetermined order is associated with a predetermined subject.

12. The video conferencing system of claim 9, wherein the predetermined order comprises a chronological order.
